(19) United States
(12) Patent Application Publication
(10) Pub. No.: US 2017/0036656 A1
(43) Pub. Date: Feb. 9, 2017

(54) HYDRAULIC CONTROL SYSTEM FOR PARKING BRAKE

(71) Applicant: Caterpillar Inc., Peoria, IL (US)

(72) Inventors: Ernest E. Stoops, Decatur, IL (US); Srikalyan C. Puranam, Naperville, IL (US); Adam Adeeb, Seaham (GB)

(73) Assignee: Caterpillar Inc., Peoria, IL (US)

(21) Appl. No.: 14/818,338

(22) Filed: Aug. 5, 2015

(51) Int. Cl. B60T 13/14; B60T 13/68

(52) U.S. Cl. CPC B60T 13/141; B60T 13/686

(57) ABSTRACT

A hydraulic control system for a machine, the machine having a service brake and a parking brake, includes a hydraulic fluid tank, a pump configured to withdraw hydraulic fluid from the hydraulic fluid tank, and a first accumulator and a second accumulator fluidly connected to the pump. The first and second accumulators configured to supply the hydraulic fluid to the service brake and the parking brake. Further, a resolver valve fluidly coupled between the first and second accumulators and configured to selectively supply the hydraulic fluid from one of the first and second accumulators to the parking brake.

### TECHNICAL FIELD

The present disclosure relates generally to a method and system of releasing a parking brake of a machine, in particular, to a hydraulic control system for the parking brake of the machine.

### BACKGROUND

Machines employ a brake system including a service brake for braking during travelling of the machine. Machines are also provided with a fail-safe parking brake for keeping the machine stationary. The parking brake may be a spring-driven, hydraulic-releasing brake. A hydraulic control system having a plurality of fluid component is used in cooperation for applying and releasing the service brake and the parking brake.

The hydraulic control system includes a hydraulic fluid tank, a pump which is fluidly connected to a first pressure storage means and second pressure storage means, for example a first service braking accumulator and a second service braking accumulator. The pump is configured to withdraw fluid from the hydraulic oil tank and output it into the first and second service braking accumulators. The first and second service braking accumulators are connected, via a service brake valve, with the service brake consisting of a front axle brake and a rear axle brake. The hydraulic system further includes a parking brake accumulator in fluid communication with the pump. The parking brake accumulator is connected, via a parking brake valve, with the parking brake. The parking brake is typically used with a power transmission system of the machine for emergency parking.

### SUMMARY

In an aspect, the present disclosure is directed to a hydraulic control system for a parking brake of a machine. The hydraulic control system includes a hydraulic fluid tank, a pump configured to withdraw hydraulic fluid from the hydraulic fluid tank, and a first accumulator and a second accumulator fluidly connected to the pump. The first and second accumulators configured to supply the hydraulic fluid to the service brake and the parking brake. Further, a resolver valve fluidly coupled between the first and second accumulators and configured to selectively supply the hydraulic fluid from one of the first and second accumulators to the parking brake.

In another aspect, a method for releasing a parking brake in the machine is provided. The method includes charging the first accumulator and the second accumulator from the hydraulic fluid tank and to supply the hydraulic fluid to the service brake and the parking brake. Determining which of the first and second accumulators is at relatively higher pressure. Further, the method includes supplying hydraulic fluid from the determined higher pressure accumulator to release the parking brake.

### BRIEF DESCRIPTION OF THE DRAWINGS

FIG. 1 is a diagrammatic illustration of an exemplary machine;

FIG. 2 is a schematic illustration of an exemplary disclosed hydraulic control system that may be used with the machine of FIG. 1; and

FIG. 3 is a flowchart depicting an exemplary disclosed method that may be performed by the hydraulic control system of FIG. 2.

### DETAILED DESCRIPTION

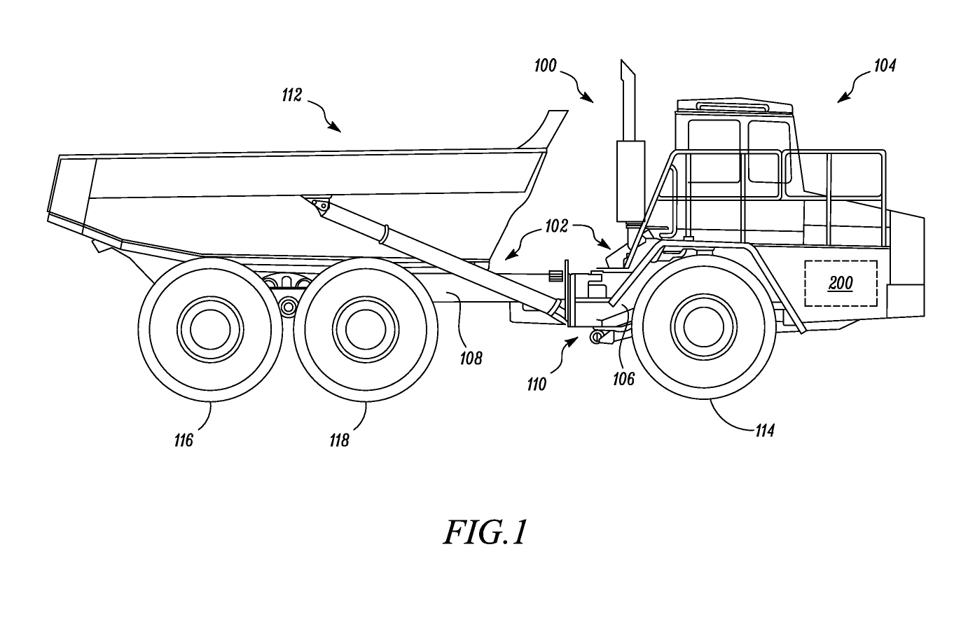

FIG. 1 illustrates an exemplary machine 100, embodied as an articulated truck for carrying a load through a plurality of work cycles. The machine 100 having a frame assembly 102 and an operator compartment 104. The frame assembly 102 has a front portion 106 and a rear portion 108. An articulation joint 110 connects the front and rear portions 106, 108 and allows for a pivotable movement about the articulation joint 110. A body 112 is installed on the rear portion 108. A pair of front wheels 114 is provided on the front portion 106, while a first pair of rear wheels 116 and a second pair of rear wheels 118 are provided on the rear portions 108. The machine 100 may further include an engine and a transmission for receiving the torque and transferring the torque to the front and rear wheels 114, 116, 118 via a drivetrain. The machine 100 is provided with a brake system 200 adapted to control the braking of the machine 100.

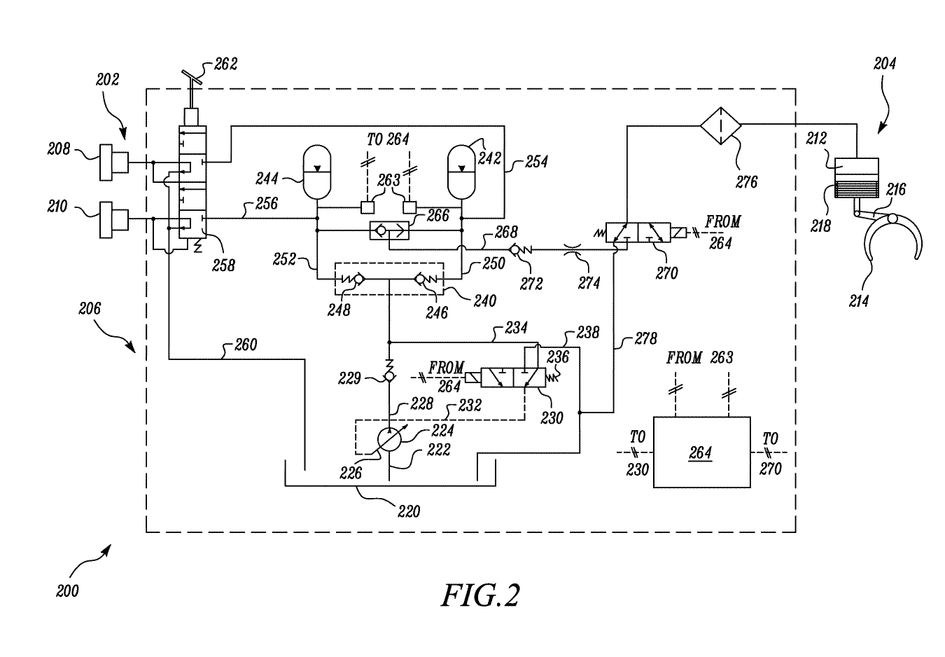

FIG. 2 illustrates the brake system 200 of the machine 100, the brake system 200 includes a service brake 202, a parking brake 204, and a hydraulic control system 206 for applying and releasing the service brake 202 and also for releasing the parking brake 204. The hydraulic control system 206 of the machine 100 may be an independent control system. The service brake 202 may include one or more hydraulic brake assemblies, such as, e.g., a front brake assembly 208 and a rear brake assembly 210. The front brake assembly 208 and the rear brake assembly 210 may include respective brake calipers or friction pads to engage with respective discs coupled with the wheels 114, 116 and 118. In one example, the parking brake 204 includes a spring-driven, hydraulically-releasing brake having a parking brake actuator 212 connected with brake shoes 214 via a link rod 216. The parking brake actuator 212 may be of any suitable design, however in an embodiment it includes a double-acting piston connected to the link rod 216 and including a compression spring 218 biasing the piston in a direction to engage the brake shoes 214 with the drivetrain of the machine 100.

According to an embodiment of the present disclosure, the hydraulic control system 206 may include a hydraulic fluid tank 220, a pump 224 configured for withdrawing hydraulic fluid such as, oil, from the hydraulic fluid tank 220 through a pump supply conduit 222. The pump 224 may be a variable positive displacement pump such that movement of a swashplate 226, which is contained within the pump 224, controls the output of the pump 224 from zero to maximum. In an embodiment, a solenoid operated valve 230 is used to provide a pressure feedback via a signal conduit 232 to control the output from the pump 224. As illustrated, the solenoid operated valve 230 can be a two-position, three-way valve. In a first position (as illustrated in FIG. 2) of the solenoid operated valve 230, a pump discharge pressure is communicated from a main supply conduit 228 to the signal conduit 232 via a discharge conduit 234 and an internal passage formed in the solenoid operated valve 230, and a tank port of the solenoid operated valve 230 is blocked. In a second position of the solenoid operated valve 230, a tank pressure from the tank 220 is communicated from a drain conduit 238 to the signal conduit 232 via the internal passage formed in the solenoid operated valve 230, and a pump discharge port of the solenoid operated valve 230 is blocked. As illustrated in FIG. 2, the solenoid operated valve 230 may be biased to the first position via a spring 236.

At an end of the main supply conduit 228 an accumulator valve assembly 240 is provided. The output from the pump 224, via the main supply conduit 228, is supplied to at least one of a first accumulator 242 and a second accumulator 244, and the accumulator valve assembly 240 controls pressure at the first accumulator 242 and the second accumulator 244. In one example, two branch conduits 250, 252 in fluid communication with the main supply conduit 228 lead to the first and second accumulators 242, 244 respectively. In on example, each of the branch conduits 250, 252 have a check valve 246, 248 being arranged in an opposing manner in the accumulator valve assembly 240. The accumulator valve assembly 240 may be fluidly connected to the first accumulator 242, that is, e.g., a front braking accumulator, and the second accumulator 244, that is, e.g., a rear braking accumulator, via the respective check valves 246, 248. The check valves 246, 248 are configured to provide one-way flow direction when opened based upon a predetermined pressure as provided with the force setting of respective springs. Further, a check valve 229 can be disposed upstream of the accumulator valve assembly 240 and the connection of the discharge conduit 234. The check valve 229 is configured to provide one-way flow direction when opened based upon a predetermined pressure as provided with the force setting of spring.

The pump 224 can be used for other hydraulic functions in the machine 100, but is mainly used for charging the accumulators 242, 244 when a fluid pressure is determined to be lower than a threshold pressure. In one example, a controller 264 is operatively connected with pressure sensors 263. The pressure sensors 263 are configured to generate accumulator pressure signals indicative of the fluid pressure at the accumulators 242, 244. The controller 264 may control the operation of the pump 224, to maintain the fluid pressure equal to or more than the threshold pressure, by controlling the solenoid operated valve 230 for changing the position of the swashplate 226. The controller 264 may include a processor and a memory component. The processor may include microprocessors or other processors as known in the art. In some embodiments the processor may include multiple processors. The processor may execute instructions for determining the fluid pressure of the accumulators 242, 244 and calculating the position of the swashplate 226 to maintain the threshold pressure at the accumulators 242, 244.

The first accumulator 242 and the second accumulator 244, respectively, may be connected, by means of a service brake valve 258, with the front brake assembly 208 and the rear brake assembly 210. A first braking conduit 254 and a second braking conduit 256 are provided to fluidly couple the first and the second accumulators 242, 244 with the service brake valve 258. Further, an operator input device, such as a brake pedal 262, provided in the operator compartment 104, may be activated by an operator during service braking. As a result, the service brake valve 258 is moved to an open position to permit fluid to be discharged from the first accumulator 242 and the second accumulator 244 for supply to the front brake assembly 208 and the rear brake assembly 210, respectively, and tank ports of the service brake valve 258 are blocked. The pressurized hydraulic fluid urges a brake caliper to engage a corresponding disc to apply brake on the wheels 114, 116, and 118. In a closed position (as illustrated in FIG. 2), the service brake valve 258 is moved to a position to connect the brake assemblies 208, 210 to the hydraulic fluid tank 220 via a drain line 260 and the accumulator supply ports of the service brake valve 258 are blocked. In order to move the machine 100, the brake pedal 262 may be released and the service brake valve 258 is moved to the closed position to discharge the pressurized hydraulic fluid into the hydraulic fluid tank 220 via the drain line 260 connecting the service brake valve 258 and the hydraulic fluid tank 220. This depressurizes the front brake assembly 208 and the rear brake assembly 210 and releases the service brake 202 so that the machine 100 is movable.

According to an embodiment of the present disclosure, the parking brake 204 is also fluidly coupled to the first and second accumulators 242, 244. The first and second accumulators 242, 244 can be discharged to the parking brake actuator 212 via a parking brake conduit 268. Further, a parking brake control valve 270 is coupled to the parking brake conduit 268 and operable to control the supply the hydraulic fluid from one of the first and second accumulators 242, 244 to the parking brake 204. The parking brake control valve 270 may be a two-position, three-way valve, as shown. In a first position (as illustrated in FIG. 2), the tank pressure is communicated from a drain conduit 278 to a first portion of the parking brake conduit 268 via an internal passage formed in the parking brake control valve 270 and an accumulator supply port of the parking brake control valve 270 is blocked. In a second position, accumulator pressure from a second portion of the parking brake conduit 268 is communicated to the first portion of the parking brake conduit 268 via internal passage formed in the parking brake control valve 270 and a drain port of the parking brake control valve 270 is blocked. As shown, the parking brake control valve 270 may be biased to the first position via a spring.

According to an embodiment of the present disclosure, a resolver valve 266 is fluidly coupled between the branch conduits 250, 252 leading to the first and second accumulators 242, 244. In an embodiment, the resolver valve 266 may be a shuttle valve configured to selectively supply the hydraulic fluid from one of the first and second accumulators 242, 244, whichever is relatively at the higher pressure, into a hydraulic flow path, via the second portion of the parking brake conduit 268 connected to the parking brake control valve 270. A one-way check valve 272 and a flow restriction valve 274 may be included to control the pressure and flow characteristics of the fluid to the parking brake actuator 212. Moreover, a filter 276 may be disposed on the first portion of the parking brake conduit 268 between the parking brake control valve 270 and the parking brake actuator 212. The parking brake control valve 270 may be a solenoid operated valve or manually operated by the operator to selectively supply the pressurized hydraulic fluid into the parking brake actuator 212 and release the parking brake 204. According to an embodiment, in order to release the parking brake 204, the controller 264 may command signal to move the service brake valve 258 in the second position and supply the pressurized hydraulic fluid into the parking brake actuator 212. The pressurized hydraulic fluid acts against the compression spring 218 and move apart the brake shoes 214 via the link rod 216 and releases the parking brake 204.

According to another embodiment of the present disclosure, the resolver valve 266 may a electro-hydraulic valve (EH valve) and can be controlled by the controller 264 to control and to selectively supply the hydraulic fluid from one of the first and second accumulators 242, 244 to the parking brake 204 based on the pressure sensors 263 readings.

### INDUSTRIAL APPLICABILITY

The brake system 200 can be used in various machines, such as a loader, a grader, an excavator, and other heavy machinery. The machine may be a tractor or any other type of machine associated with certain operations for industries, such as mining, construction, agriculture, and transportation. The disclosed hydraulic control system 206 may help to reduce parts and save cost by utilizing the service braking accumulators alone for releasing the parking brake 204.

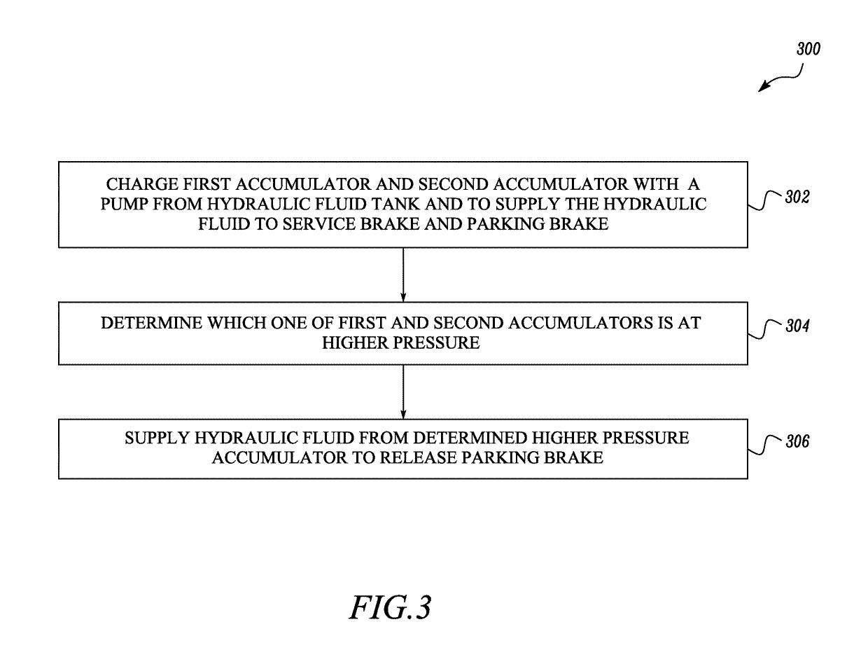

FIG. 3 illustrates an exemplary flowchart 300 disclosing operation of the hydraulic control system 206. At step 302, the service braking accumulators, such as the first accumulator 242 and the second accumulator 244, are charged and maintained at a pre-determined pressure to supply the pressurized hydraulic fluid to the service brake 202. The operator may actuate the brake pedal 262 from the operator compartment 104 and the controller 264 may command a signal to the service brake valve 258 to move to the open position to allow for braking the travelling motion of the machine 100. At step 304, based on an instruction from the operator and the controller 264 may command a signal to the solenoid of the parking brake control valve 270 to move to the second position, for releasing the parking brake 204. The resolver valve 266 or the controller 264 determines which one of the first and second accumulators 242, 244 is at higher pressure. The resolver valve 266 embodied as the shuttle valve may selectively open the hydraulic flow path between the parking brake conduit 268 and the one of the accumulators 242, 244, which is at higher pressure. Alternatively, the controller 264 may rely on the readings from the pressure sensors 263 to selectively open the hydraulic flow path between the parking brake conduit 268 and the one of the accumulators 242, 244. At step 306, the hydraulic flow path between the parking brake actuator 212 and one of the first and second accumulators 242, 244, that is the determined higher pressure accumulator, is used to supply the hydraulic fluid to the parking brake 204. The pressurized hydraulic fluid enters the parking brake actuator 212 and acts against the compression spring 218 to move apart the brake shoes 214.

Various benefits are associated with the present disclosure, particularly with the disclosed hydraulic control system 206. First, the hydraulic control system 206 utilizes service braking accumulators (i.e., the accumulators 242, 244), during releasing of the parking brake 204. This not only avoids need for an extra dedicated parking brake accumulator, but also reduces load on the pump 224 of charging and maintaining pressure in that extra dedicated accumulator. Second, use of the shuttle valve as the resolver valve 266 provides an inexpensive and retrofittable solution as compared to other expensive sensor based, electro-mechanical or electro-hydrostatic actuators. The shuttle valve may also reduce complexity and associated cost of the hydraulic control system 206. Third, the disclosed hydraulic control system 206 reduces dependencies in the likelihood of failure of one of the accumulators 242 or 244 and still provides proper working of the parking brake 204.

It will be apparent to those skilled in the art that various modifications and variations can be made to the disclosed hydraulic control system. Other embodiments will be apparent to those skilled in the art from consideration of the specification and practice of the disclosed hydraulic control system. It is intended that the specification and examples be considered as exemplary only, with a true scope being indicated by the following claims and their equivalents.

We claim:

1. A hydraulic control system for a machine having a service brake and a parking brake, comprising:
a hydraulic fluid tank;
a pump configured to withdraw hydraulic fluid from the hydraulic fluid tank;
a first accumulator and a second accumulator fluidly connected to the pump, the first and second accumulators configured to selectively supply the hydraulic fluid to both of the service brake and the parking brake; and
a resolver valve fluidly coupled between the first and second accumulators and configured to selectively supply the hydraulic fluid from one of the first and second accumulators to the parking brake.

2. The hydraulic control system of claim 1, wherein the resolver valve is a shuttle valve configured to selectively supply the hydraulic fluid from one of the first and second accumulators, which is at relatively higher pressure, to the parking brake.

3. The hydraulic control system of claim 1 further comprising a parking brake control valve fluidly connected to the resolver valve to control the supply the hydraulic fluid from one of the first and second accumulators to the parking brake.

4. The hydraulic control system of claim 3, wherein the parking brake control valve connected with the hydraulic fluid tank.

5. The hydraulic control system of claim 1 further comprising a service brake valve fluidly connected to the first and second accumulators to control the supply the hydraulic fluid from the first and second accumulators to the service brake.

6. The hydraulic control system of claim 5, wherein the service brake valve connected with the hydraulic fluid tank.

7. A machine comprising:
a service brake;
a parking brake, and
a hydraulic control system including:
a hydraulic fluid tank;
a pump configured to withdraw hydraulic fluid from the hydraulic fluid tank;
a first accumulator and a second accumulator fluidly connected to the pump, the first and second accumulators configured to supply the hydraulic fluid to both of the service brake and the parking brake; and
a resolver valve fluidly coupled between the first and second accumulators and configured to selectively supply the hydraulic fluid from one of the first and second accumulators to the parking brake.

8. The machine of claim 7, wherein the resolver valve is a shuttle valve configured to selectively supply the hydraulic fluid from one of the first and second accumulators, which is at relatively higher pressure, to the parking brake.

9. The machine of claim 7, wherein the hydraulic control system further including a parking brake control valve fluidly connected to the resolver valve to control the supply the hydraulic fluid from one of the first and second accumulators to the parking brake.

10. The machine of claim 9, wherein the parking brake control valve connected with the hydraulic fluid tank.

11. The machine of claim 7, wherein the hydraulic control system further including a service brake valve fluidly connected to the first and second accumulators to control the supply the hydraulic fluid from the first and second accumulators to the service brake.

12. The machine of claim 11, wherein the service brake valve connected with the hydraulic fluid tank.

13. The machine of claim 7, wherein the service brake including a front brake assembly and a rear brake assembly.

14. The machine of claim 7, wherein the parking brake including a spring-driven, hydraulically-releasing brake.

15. The machine of claim 7, wherein the parking brake including parking brake actuator connected with a brake shoe via a link rod.

16. The machine of claim 15, wherein the parking brake further including a compression spring disposed in the parking brake actuator.

17. A method for releasing a parking brake in a machine having a service brake and the parking brake, comprising:
charging a first accumulator and a second accumulator with a pump withdrawing hydraulic fluid from a hydraulic fluid tank, wherein the first accumulator and the second accumulator is fluidly coupled to the service brake and the parking brake;
determining which of the first and second accumulators is at relatively higher pressure; and
supplying hydraulic fluid from the determined higher pressure accumulator to release the parking brake.

18. The method of claim 17, wherein determining which of the first and second accumulators is at relatively higher pressure comprises providing a resolver valve disposed between the first and second accumulators.

19. The method of claim 18, wherein supplying hydraulic fluid from the determined higher pressure accumulator to release the parking brake comprises connecting a hydraulic flow path between the resolver valve and a parking brake control valve.

20. The method of claim 17, wherein supplying hydraulic fluid from the first and second accumulators to the service brake comprises connecting a hydraulic flow path between the first and second accumulators and a service brake valve.
